(19) United States
(12) Patent Application Publication
(10) Pub. No.: US 2002/0016171 A1
(43) Pub. Date: Feb. 7, 2002

(54) MOBILE UNIT LOCATION SYSTEM FOR AUTOMATICALLY REPORTING TO A CENTRAL CONTROLLER AND SUBSCRIBER THE PROXIMITY OF MOBILE UNITS TO A DESTINATION

(76) Inventors: YURDAER N. DOGANATA, CHESTNUT RIDGE, NY (US); BAHADIR S. KARUV, RUTHERFORD, NJ (US); ASSER N. TANTAWI, SOMERS, NY (US); ERIC THALASINOS, RUTHERFORD, NJ (US)

Correspondence Address: F CHAU & ASSOCIATES, 1900 HEMPSTEAD TURNPIKE SUITE 501, EAST MEADOW, NY, 11554

(21) Appl. No.: 09/163,535

(22) Filed: Sep. 30, 1998

(51) Int. Cl. H04Q 7/20

(52) U.S. Cl. 455/456; 701/201

(57) ABSTRACT

A system and method for providing proximity notification to subscribers of a distributed system. The system includes mobile units having location receivers and stored information regarding target subscribers wherein upon a mobile unit reaching a given proximity criteria, the target subscriber is notified.

### BACKGROUND OF THE INVENTION

1. Technical Field

The present invention relates to a distributed navigation and proximity notification system and method, and in particular, a system and method for sending subscriber location information to mobile units and notify subscribers when the mobile unit approaches the subscriber's proximity.

2. Description of Related Art

Finding the locations of moving objects and the use of the information thereof have always attracted attention. Navigators used numerous techniques or devices to determine locations, including compasses, motion of stars, death reckoning by using maps, radio signaling, etc. Global Positioning System (GPS) is the latest technology in navigation and location determination. Generally, the GPS uses satellites which send precisely-timed radio signals which are received by GPS receivers. Based on the reception of the radio signals and the timing information therein, the GPS receivers then determine the latitude, longitude and the elevation by calculating the time it takes for the signal to reach the receiver. See Walker, J. “Mobile Information Systems,” Artech House, Boston, 1990, for operations of GPS systems.

With the use of the GPS, mobile units such as moving vehicles equipped with GPS receivers can determine their precise location at all times. Usage of such information can be found in the National Intelligent Transportation System architecture, IVHS Architecture Bulletin, ITS America, September 1994. In such system, vehicles send their location information to a communication center by using a wireless communication system. In U.S. Pat. No. 5,610,821, “Optimal and stable route planning system”, the vehicles send their locations to the center along with the travel time of traveled road segments. The center then computes and returns the optimal routing for the vehicles. Recently, taxi and limousine services use GPS to communicate with the center. The operators collect the location information and guide the taxicabs for their next customer. In these systems, a centralized system collects information about the locations of the mobile units, processes, and distributes this information to other mobile units. The commuters or the taxi drivers receive communications from the central system to bypass traffic or reach their customers in a more timely fashion.

Proximity information between two or more objects or customer/server providers are not available in many cases where at least one of these objects is not fixed but in motion. As an example, the customer might be in a fixed location (residential, business, . . . ), whereas a service provider might be a moving vehicle providing services such as delivery or pickup of goods or people. In this case, the availability of proximity information between the customer and the server would be very helpful. If the proximity information is not available, there is always an uncertainty about the location of the mobile unit. Hence, the customer cannot anticipate the timely arrival of the server. As an example, small children or people with physical challenges have to be ready in advance to catch a bus service. If they are notified in advance about the location or proximity of the bus, the lost time in preparing and waiting for the bus can be minimized.

A need therefore exists for a system and method for navigating and communicating between a mobile service provider and a customer for notifying the customer when the service provider is about to reach the customer.

### SUMMARY OF THE INVENTION

A proximity notification system is provided, comprising a communication center for communicating with mobile units over a wireless communication network and communicating with a subscriber over a notification system, each of the mobile units including: a position tracking device for tracking navigational position of each of the mobile units, a memory for storing a target area, means, coupled to the position tracking device and the memory, for determining if the mobile unit lies within the target area, and upon determining that the mobile unit lies within the target area, communicating a signal to the communication center indicating that the mobile unit lies within the target area, whereby the communication center generates a message based upon the signal communicated from the mobile unit, and communicates the message to the subscriber over the notification system.

Preferably, the position tracking device is a GPS receiver. The target area is preferably a predefined distance in miles, or a predefined time, e.g., in minutes estimated to reach the subscriber. The communication center may communicate the notification message to the subscriber through a PSTN, and the subscriber may forward subscriber information to the communication center via a data network. The data network preferably being the Internet. The subscriber information may include subscriber address and type of service requested. Such subscriber information may be stored in the memory of a mobile unit. Further, the memory preferably stores location information in GPS format in rectangular coordinates.

A proximity notification method is also provided which comprises the steps of communicating with a plurality of mobile units from a communication center over a wireless communication network, receiving at said communication center subscriber information from a subscriber, position tracking each of said mobile units, selecting one of said mobile units to travel to said subscriber, storing target information relating to said subscriber in said selected mobile unit, determining at said selected mobile unit when said mobile unit lies within a target area specified in said target information, communicating a signal to said communication center indicating that said selected mobile unit lies within said target area, and generating a message based upon said signal communicated from said mobile unit at said communication center, and communicating said message to said subscriber.

### BRIEF DESCRIPTION OF THE DRAWINGS

The operation and utilization of the present invention will be more fully apparent from the following description taken in conjunction with the drawings, in which:

FIG. 1 shows a navigation and proximity notification system according to the present invention;

FIG. 2 shows the major components of a mobile unit according to the present invention; and

FIG. 3 shows the major components of a data processing and communication center according to the present invention.

### DESCRIPTION OF PREFERRED EMBODIMENTS

The invention described herein accomplishes the above-described need by monitoring the location of the moving vehicle via a location determination device such as a GPS receiver, comparing the location of the mobile unit to the location of the customer by using a proximity criterion, and initiating a phone call (or other notification calling means) to the customer whenever the proximity criterion is satisfied.

A user of this system (subscriber) sends his/her location information and a telephone number where he/she can be reached to the mobile unit through a communication center. When the mobile unit enters into a region where the proximity criteria is satisfied, it sends a signal to the communication center to notify the user that its location is close enough to the user. The user is notified by notification means, preferably by telephone, about the location of the mobile unit and the user is prepared to receive service.

In the invention described here, the customer can send a service request along with their location information to vehicles from their homes or offices via a central communication system. The vehicles that are equipped with a location determination device compares their locations to the location information that they received from their customers. When they approach the proximity of a customer, they send a signal to a communication center to invoke a notification process. Hence, the customers are notified that the vehicles they are waiting for is approaching. This invention makes it possible for users to send their location information to the vehicle of their interest. Furthermore, the customers can choose a notification type that is most convenient to them. A typical notification system can be implemented as a telephony system that calls the users based on the notification signal received from the vehicles.

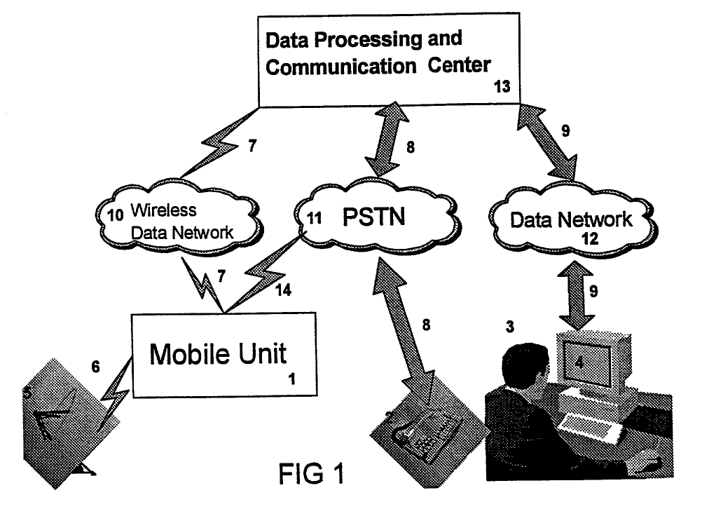

FIG. 1 shows major components of an illustrative embodiment of the navigation and proximity notification system according to the present invention. Data Processing and Communication Center (DPCC) 13 controls and manages the communications between subscriber 3 of the system and mobile unit 1. The subscriber 3 forwards subscriber information 9 to the DPCC 13. The subscriber information 9 includes information for identifying the subscriber, the types of services requested and data for DPCC to return communication with the subscriber. For example, the subscriber information may include the subscriber's telephone number, address, and a type of service requested, such as vendor delivery. The subscriber information may be sent by the subscriber over terminal 4 via data network 12 or by use of a telephone 2 via public service telephone network (PSTN) 11 to DPCC 13. Preferably, the data network 12 is the Internet. The DPCC 13 receives the subscriber information from the subscriber. The address of the subscriber is converted into GPS data format and a mobile unit is selected based on the service type selected. For example, if the service requested is limousine or car services, the car closest to the subscriber is selected. The DPCC 13 then establishes communication, preferably a wireless communication link 7, with the mobile unit selected for providing the requested service. The subscriber information is sent to the mobile unit over a wireless data network 10, which can be one of the commercially available networks such as Ardis, CDPD, etc. The subscriber information is stored on the on-board memory or database of the selected mobile unit.

According to the illustrative embodiments of the present invention, the mobile unit 1 is equipped with a GPS receiver which receives location information 6 from a constellation of satellites 5. The mobile unit 1 determines its position by reading the current location output by the GPS receiver which continuously monitors the signals coming from the satellites and calculates the location. The mobile unit then compares its location to the subscriber information received from DPCC 13. As a result of this comparison, the mobile unit determines its distance to the target subscriber location. A predefined proximity criteria may be a geographical distance in meters or miles or an amount of time calculated to reach the target subscriber. The time it takes to reach the target depends on the current location and the speed of the mobile unit, as well as its distance to the target. Hence, the proximity criteria is satisfied when the estimated time to reach the target is less than a certain predefined value. Preferably, the estimated time to reach the target is calculated automatically based on the GPS receiver outputs by an on-board processor in real time. The speed of the mobile unit is also one of the outputs of the GPS receiver. The following equation is preferably used to estimate the time to the target:

Average time to target=distance from the target*location factor/speed of the mobile unit

The location factor is a parameter with a value between 0 and 1 and it depends on the geographical area. The location factor takes into account the fact that the targets are not always in the path of the mobile unit and it can be statistically determined for every region and loaded initially to mobile units.

When a proximity criteria is satisfied, which means that the mobile unit has reached the predefined distance or the time of arrival from the subscriber who requested the service, then, the mobile unit sends a notification signal to DPCC 13 over the Wireless Data Network 10, requesting this subscriber be notified. The notification signal includes the identification of the subscriber. DPCC 13 retrieves the subscriber's telephone number from customer profile database and contacts the subscriber. The DPCC 13 may include an estimated time of arrival of the mobile units to the subscriber in communicating with the subscriber. Alternatively, the mobile units that are equipped with telephony network interface may send a message 14 to the DPCC by cellular telephone or call the subscriber by directly dialing via PSTN 11.

After receiving the notification signal from the mobile unit 1, DPCC 13 notifies the subscriber that the mobile unit 1 is in the proximity via PSTN 11 by voice message 8. The voice message can be a pre-recording which tells the subscriber that the mobile unit is approaching to provide the service that has been requested. Other notification means via wireless or data networks for notifying the subscriber are also within contemplation of the present invention.

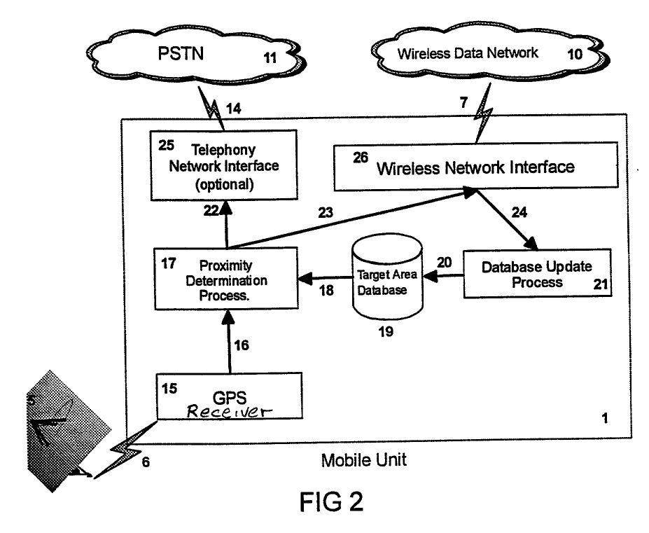

FIG. 2 shows the major components of a mobile unit 1 which includes a location determination device 15, proximity determination process 17, Target Area Database 19, Database Update Process 21, Wireless Network Interface 26 and Telephony Network Interface 25. Preferably, the location determination device is a GPS receiver capable of necessary GPS signals from a constellation of satellites 5 and outputs position and speed information. The proximity determination process 17 includes a processor and stored programs for receiving position and/or speed information 16 for the GPS receiver 15 and for processing such information. The Telephony Network Interface may be optional for purposes of directly contacting the subscriber from the mobile unit. The mobile unit determines its location by using a location determination device 15. The proximity determination process 17 compares the location data 16 to user location information 18, which is stored in the Target Area Database 19. Based on a proximity criteria, the proximity determination process 17 decides if the mobile unit 1 is within the target area. When the mobile unit approaches the target area and the criteria is satisfied, a notification signal 23 (or 22) is generated. Then the notification message 7 is sent to DPCC 13 over the wireless data network 10. If the device is equipped with a telephony network interface 25, telephony notification message 14 is directly sent to the user 3 via PSTN 11.

According to another illustrative embodiment of the present invention, the functions of Proximity Determination Process 17, Target Area Database 19 and Database Update Process 21 can be performed in the DPCC 13. In such embodiments, mobile units need only a GPS receiver 15 and forwards the GPS receiver outputs to DPCC 13 over the telephony or wireless data network.

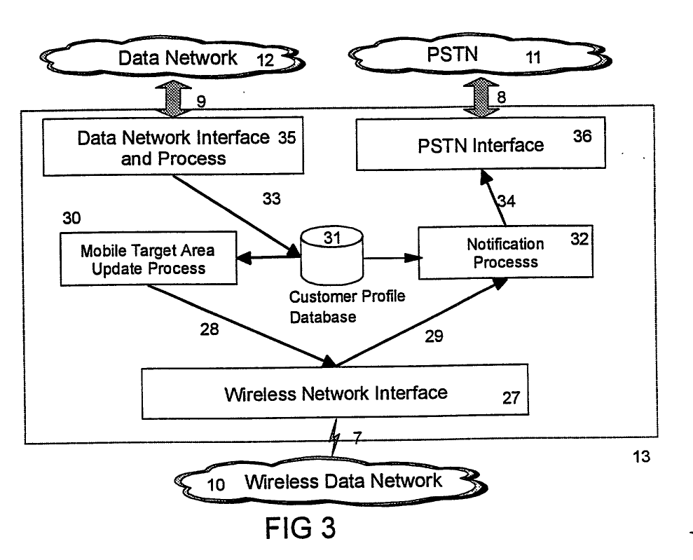

FIG. 3 shows the major components of Data Process and Communication Center 13 (DPCC), which includes Data Network Interface 35, PSTN interface 36, Wireless Network Interface 27, Customer Profile Database 31, Notification Process 32 and Mobile Target Area Update Process 30.

DPCC 13 receives subscriber information 9 over the Data Network 12 through Data Network Interface and Process 35. Data Network Interface and Process 35 buffers, processes and writes the subscriber information data 33 to Customer Profile Database 31. The subscriber information 9 is processed to convert the postal address of the subscriber into GPS data format. The Customer Profile Database keeps a record containing the geographical location, telephone number and service type, etc. for each subscriber.

An example of a subscriber information data record has the following format:

TABLE 1
Subscriber Information Data Structure

| Message Header Description | Message Data |
|---|---|
| User Identification | First Name, Last Name, id no |
| User location | X, Y, Z (GPS format in |
| | rectangular coordinates) |
| Telephone Number | 1-555-555-5555 |
| Service Type | Type A |

Mobile Target Area Update Process 30 associates mobile units with the types of services requested by the subscribers. That is, for every service request, Mobile Target Area Update Process assigns mobile units to subscribers for service depending on the availability of the mobile units and the geographical location of the subscriber.

As an example, when the subscriber information described in Table 1 is received, the mobile unit that is associated with service type A is preferably found from a look up table (not shown) by the Mobile Target Area Update Process 30. Once the mobile unit that provides service Type A is determined, Mobile Target Area Update Process 30 sends the location of the subscriber in GPS format to the selected mobile unit 1 over the Wireless Network 10. The new location that is received by the mobile unit becomes a target area. Hence, for every request that is filed into the Customer Profile Database 31, mobile target update process 30 updates each target area database 19 that is located in each mobile unit 1 by sending related subscriber information 28 through the wireless network user interface 27.

A data record in Target Area Database 19 preferably has the following structure:

Target Area Database data structure

| | |
|---|---|
| User Location | X, Y, Z (GPS format in |
| | rectangular coordinates) |
| Telephone Number | 1-555-555-5555 |
| User Identification | First Name, Last Name, id no |

DPCC 13 also listens to each mobile unit for respective notification signals 23 sent by the mobile units when the proximity criteria is satisfied. The notification signal 23 includes subscriber identification. DPCC 13 then notifies the user who is in the proximity of the corresponding mobile unit by sending a notification message through a PSTN interface.

What has been described is merely illustrative of the invention. Other embodiments known to those skilled in the art could be utilized without departing from the spirit and scope of the present invention. Additionally, other applications to navigation, notification or communication systems other than the disclosed system are contemplated as being within the knowledge of one skilled in the art.

What is claimed is:

1. A proximity notification system comprising:
a communication center for communicating with mobile units over a wireless communication network and communicating with a subscriber;
each of said mobile units including:
position tracking means for tracking its navigational position;
a memory for storing information on a target; and
means, coupled to said position tracking means and said memory, for determining if said mobile unit lies within said target, and upon determining that said mobile unit lies within said target area, communicating a signal to said communication center indicating that said mobile unit lies within said target area,
whereby said communication center generates a message based upon said signal communicated from said mobile unit, and communicates said message to said subscriber.

2. The system according to claim 1, wherein said position tracking means is a GPS receiver.

3. The system according to claim 1, wherein said target is a predefined distance.

4. The system according to claim 1, wherein said target is a predefined time.

5. The system according to claim 1, wherein said communication center communicates with said subscriber through a PSTN.

6. The system according to claim 1, wherein said subscriber forwards subscriber information to said communication center via a data network.

7. The system according to claim 6, wherein said data network is the Internet.

8. The system according to claim 6, wherein said subscriber information includes subscriber address and type of service request.

9. The system according to claim 6, wherein said memory of a mobile unit stores said subscriber information forwarded from said communication center.

10. The system according to claim 9, wherein said memory stores location information in GPS format in rectangular coordinates.

11. A proximity notification system comprising:
a communication center for communicating with mobile units over a wireless communication network and communicating with a subscriber;
each of said mobile units including:
position tracking means for tracking its navigational position;
a memory for storing information on a target; and
means, coupled to said position tracking means and said memory, for determining if said mobile unit lies within said target, and upon determining that said mobile unit lies within said target, communicating a notification signal to said subscriber.

12. The system according to claim 11, wherein said wireless communication network is a data network for communicating subscriber data.

13. The system according to claim 11, wherein said communication center includes means for determining which of said mobile units are closer to said subscriber for selecting a selected mobile unit for servicing said subscriber.

14. The system according to claim 13, wherein said selected mobile unit communicates a notification signal to said subscriber via telephone upon determination that said target is reached.

15. The system according to claim 13, wherein said selected mobile unit communicates a notification signal to said communication center upon reaching said target, and said communication center relays a message including a notification to said subscriber of an estimated time of arrival of said mobile unit.

16. A proximity notification method comprising:
communicating with a plurality of mobile units from a communication center over a wireless communication network;
receiving at said communication center subscriber information from a subscriber;
position tracking each of said mobile units;
selecting one of said mobile units to travel to said subscriber;
storing target information relating to said subscriber in said selected mobile unit;
determining at said selected mobile unit when said mobile unit lies within a target area specified in said target information;
communicating a signal to said communication center indicating that said selected mobile unit lies within said target area; and
generating a message based upon said signal communicated from said mobile unit at said communication center; and
communicating said message to said subscriber.
